(19) United States
(12) Patent Application Publication
(10) Pub. No.: US 2007/0113867 A1
(43) Pub. Date: May 24, 2007

(54) Polymer treatment using a plasma brush

(75) Inventors: Yixiang Duan, Los Alamos, NM (US); Qingsong Yu, Columbia, MO (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/501,619

(22) Filed: Aug. 8, 2006

Related U.S. Application Data
(63) Continuation-in-part of application No. 11/286,019, filed on Nov. 22, 2005.

(51) Int. Cl. B08B 6/00; C23F 1/00; F26B 5/06; H05H 1/24

(52) U.S. Cl. 134/1.1; 34/282; 427/569; 216/67

(57) ABSTRACT

An atmospheric cold plasma brush was used to treat the surfaces of polymers. The surface properties of plasma-treated polymers were compared to those of the corresponding untreated polymers by static water contact angle measurements. Surface treatment usually resulted in a decrease in the static water contact angle, indicating that the treatment resulted in a higher surface energy and surface wettability compared to the untreated polymer.

### RELATED APPLICATIONS

This application is a continuation-in-part of copending U.S. patent application Ser. No. 11/286,019 entitled “Plasma Brush Apparatus and Method,” filed Nov. 22, 2005, incorporated by reference herein.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to polymer surface treatment and more particularly to the treatment of polymer surfaces using a stable, atmospheric plasma brush at low temperature.

### BACKGROUND OF THE INVENTION

Coating, lacquering, gluing, and other types of surface treatment are possible on plastic films only if an adequate wettability with solvent-based or water-based printing inks, lacquers, primers, adhesives, and the like exists. Traditionally, surface modification has been accomplished using chemical-based methods and technologies. Increasing concerns about groundwater and air pollution, greenhouse gases, and related health and safety issues have severely restricted the use of chemical solvents, and even many of the recently-adapted, less hazardous chemical substitutes. In addition, chemical-based methods/technologies have various limitations in functional capability for surface modification.

Plasmas have been used for modifying the surfaces of materials. Plasmas employed for materials processing generally have a low temperature and are formed by non-equilibrium discharges that are usually produced at low pressures under a vacuum. The success of plasma processing technology is related to the non-equilibrium nature of the plasma. Non-equilibrium type plasmas provide chemically active species at low thermal temperatures. Exposing the surface of a material to these species can change the surface properties and surface chemistry without significantly affecting the bulk properties of the material. Plasma treatment is “all-dry” process, generates minimal effluent, usually does not require hazardous components, and is applicable to a wide variety of vacuum-compatible materials. However, there are some disadvantages to using low pressure plasmas. Plasma processing that requires a vacuum is usually expensive due to the vacuum generating equipment, and inconvenient because the materials that are being processed must be compatible with the conditions of vacuum processing.

Plasma processing at atmospheric pressure is less expensive than vacuum-based processing, and provides an alternative that does not require the materials to be compatible with vacuum. Atmospheric pressure plasmas, while not requiring evacuation of the article being treated, generally rely on high-power radio frequency (RF) or microwave (MW) discharges that operate at high temperatures and produce substantial ionization, and polymeric materials could be destroyed under these conditions.

There remains a need for an apparatus and method for plasma processing polymeric materials at atmospheric pressure and at low temperature.

### SUMMARY OF THE INVENTION

In accordance with the purposes of the present invention, as embodied and broadly described herein, the present invention includes a method for treating the surface of a polymer. The method involves generating an atmospheric pressure plasma brush that comprises a temperature T wherein T≦300 degrees Celsius, and exposing a surface of a polymer to the plasma brush for a duration sufficient to change the surface wettability of the polymer.

The invention also includes a method for treating the surface of a polymer that involves generating an atmospheric pressure plasma brush that comprises a glow and a temperature T wherein T≦300 degrees Celsius, and positioning the glow of the atmospheric plasma brush near a surface of a polymer for a duration sufficient to change the surface wettability of the polymer.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1a shows a perspective view of an embodiment apparatus, and FIG. 1b shows a view of the embodiment after generating a plasma brush.

FIG. 2 shows a schematic representation of an embodiment plasma brush system.

FIG. 3 shows a graph of plasma temperature versus gas flow rate at different power levels for an embodiment apparatus.

FIG. 4a-e show graphs of the water contact angle in degrees versus exposure time in seconds to the plasma brush for several samples of polymer, as well as the contact angles for the untreated polymers (treatment time=0). The argon flow rate was about 1500 sccm, and the DC power input was about 15 Watts.

FIG. 5a shows a graph of static water contact angle versus distance (in millimeters) from the tip of the plasma for samples of polyethyleneterephthalate (PET) (the argon flow rate was 1500 sccm and DC power input was 15 Watts, treatment time of 10 seconds), and FIG. 5b shows a graph of temperature versus distance from the tip of the plasma to a sample.

FIG. 6a-b shows a graph of the static water contact angle in degrees versus DC powder for (a) PET and (b) nylon 6,6 after 10 seconds of exposure to the plasma.

FIG. 7a-b shows a graph of the static water contact angle in degrees versus flow rate of plasma gas for (a) PET and (b) nylon 6,6 after 10 seconds of exposure.

### DETAILED DESCRIPTION

The invention is concerned with the plasma treatment of polymer surfaces using a low temperature (i.e. less than about 300 degrees Celsius) atmospheric plasma brush.

An embodiment apparatus useful for polymer surface treatment has a walled, narrow slit gas chamber and two electrodes that are spaced apart and attached to the walls. The electrodes are inside the gas chamber. One of the electrodes is connected to a ballast resistor. When an electrical field is applied between the electrodes, a stable discharge of the plasma gas is formed between the electrodes inside the gas chamber.

Plasma gases useful with the plasma brush for treating polymer surfaces include, but are not limited to, helium, argon, nitrogen, oxygen, air, vapor of hydrocarbons, and mixtures thereof.

When the plasma brush touches the surface of a polymer, the discharge is uniformly distributed over the surface of the polymer. The dimensions of the plasma brush are determined by the gas flow rate, electrical power input, discharge chamber design, and the ratio of the chamber width to the chamber thickness.

The chamber walls are configured to provide a narrow slit gas chamber in order to fully utilize the gas flowing through the chamber so that the plasma gas passes through the chamber at a relatively high velocity. The ratio of the chamber width to the chamber thickness is preferably greater than about 5 to 1, and more preferably greater than about 10 to 1. The fast flow of plasma gas through the narrow chamber quenches thermal instabilities by convective removal of energy. As a result, the discharge created inside the gas chamber exits the chamber by the fast flowing gas and is extended outside the chamber to form a stable, low temperature plasma having a brush shape (i.e. a plasma brush). Mass flow controllers may be used for controlling the flow rates of plasma gases through the gas chamber.

An electrical field is applied to the two electrodes using a direct current (DC) power supply, or using an alternating current (AC) power supply with radiofrequency up to about 13.56 MHz in a continuous wave mode or a pulsed mode. A ballast resistor is used to suppress the electrical field fluctuations in the cathodic region and restrain the electrical current passing through the discharges to prevent glow-to-arc transition. As a result, stable discharges can be generated inside the gas chamber. The electrical voltage used to create the plasma brush ranges from several hundreds of volts to several thousands of volts and higher, with an electrical current on the order of milliamperes to tens of milliamperes, or higher, passing through the discharge.

The power consumption in generating and sustaining the stable discharge is typically on the order of several watts to tens of watts, and higher. The power consumption can be further reduced when the system operates in a pulse mode, which also generates stable discharges. The very low power consumption ensures that the plasma is at a low temperature. The plasma brush may be operated at much higher electrical power input (to hundreds of watts) if a cooling system is employed to remove heat from the plasma that would otherwise destroy a polymer substrate.

The chamber walls can be made from a polymeric material such as TEFLON®, or from insulating ceramic materials. The electrodes can be made from any heat resistant material. Preferably, the electrodes are metallic electrodes. Preferred electrode materials include, but are not limited to, tungsten, nickel, tantalum, platinum, and alloys of these materials. The ends of the electrode portions inside the gas chamber may be flat or pointed.

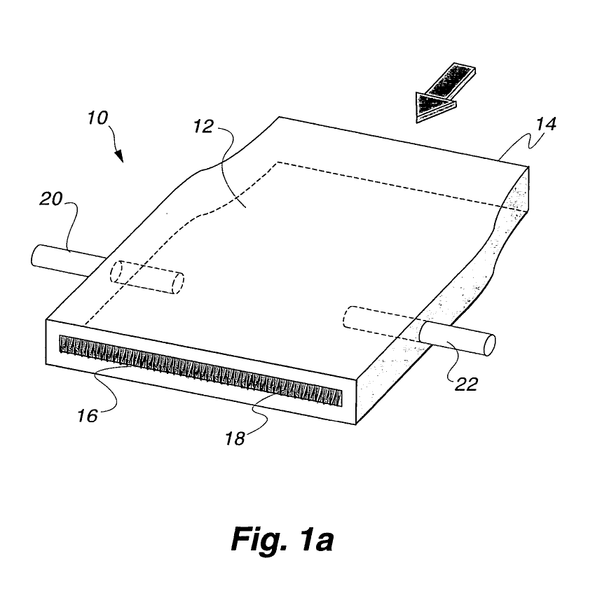

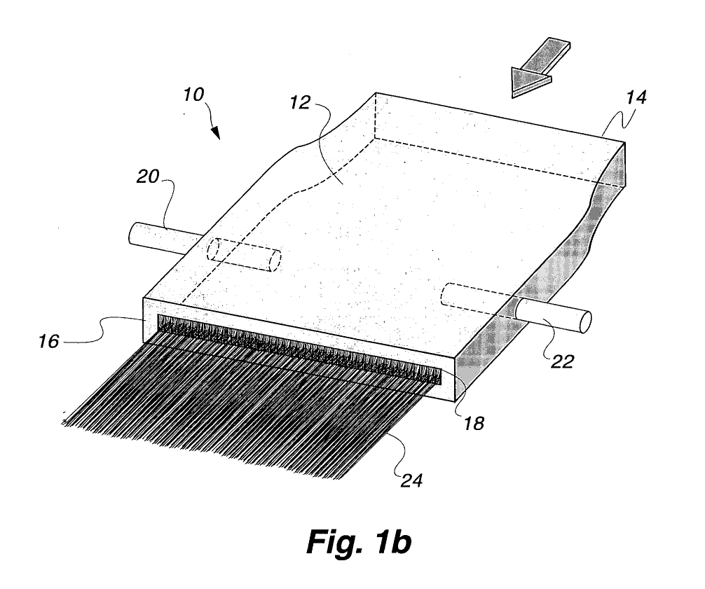

Turning now to the FIGURES, FIG. 1a shows an embodiment of a plasma brush generator of the present invention. Plasma brush generator 10 includes body 12 having first open end 14 and second open end 16. Plasma gas enters first open end 14 and travels through narrow slit chamber 18 inside body 12. Plasma brush generator 10 also includes first electrode 20 and second electrode 22. First electrode 20 and second electrode 22 are each inside body 12 near second open end 16, and are facing each other. When a sufficient potential is applied across the electrodes, a discharge is produced and plasma is generated inside chamber 18.

FIG. 1b shows a representation of plasma brush generator 10 after the discharge forms. As plasma gas continues to flow into narrow slit chamber 18, plasma generated inside the chamber is expelled through second open end 16 as a jet 24 having a brush-like shape (i.e. a plasma brush).

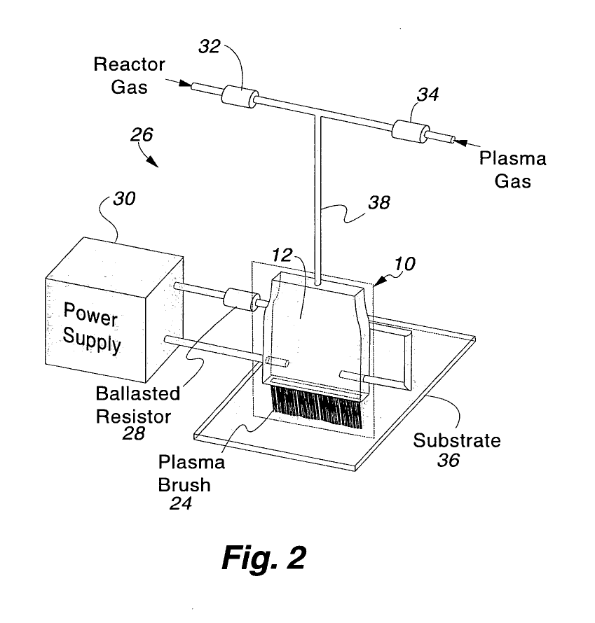

FIG. 2 shows plasma brush generator 10 as part of a larger embodiment plasma brush generating system 26. System 26 includes power supply 30, which supplies electrical power to plasma generator 10. System 26 includes ballast resistor 28 in electrical communication with power supply 30 and electrode 22 of plasma generator 10. Plasma brush generating system 26 also includes a gas feed for supplying plasma gas and reactive gas to plasma brush generator 10. System 26 includes flow controllers 32 and 34 for controlling the flow rates of plasma gas and reactive gas, respectively, into plasma brush generator 10. FIG. 2 shows how system 26 may be used in treating the surface of a polymer. The plasma brush formed from generator 10 of system 26 is directed at the surface of polymer substrate 36. Generator 10 and/or polymer substrate 36 move so that selected portions of the surface of polymer substrate 36, or the entire surface, are exposed to plasma brush 24.

While FIG. 2 shows only two feeds for two gases merging into a single gas feed, other embodiments of a plasma brush generating system of the present invention may include multiple feeds for additional gases, and additional feeds into plasma generator 10.

The dimensions of the plasma brush are mainly determined by the gas flow rate, electrical power input, ratio of the width to the thickness of the narrow slit chamber, and discharge chamber design. The chamber dimensions for a particular apparatus and application will depend on a variety of factors that include, but are not limited to, the applied power, the plasma gas flow rate, electrode size and shape, the distance between the electrodes, the slit width of the device, the length of the brush, and other factors. An embodiment apparatus for generating a stable atmospheric plasma brush, for example, was fabricated with a narrow slit chamber having dimensions of about 10 mm in width by about 1 mm in thickness. In another embodiment plasma brush generator, the electrodes were spaced apart by about 15 mm, and each electrode had a diameter of about 0.75 mm. It should be understood, however, that these are only exemplary dimensions and that the invention should not be limited to plasma gas generators with a narrow slit chamber having these dimensions.

The narrow slit gas chamber ensures efficient utilization of the gas flowing through the chamber. The gas passes through the chamber quickly. This fast and efficient gas flow also helps maintain the stability of the discharge by removing heat generated during the discharge process and quenching thermal instabilities. As a result of the fast gas flow, the gas discharge created inside the gas chamber is expelled as a stable, atmospheric, low-temperature plasma brush.

The argon plasma gas passes through the discharge chamber at a flow rate controlled by a mass flow controller. An electrical field was applied to the two electrodes located inside the chamber to ignite a DC discharge by a DC power supply.

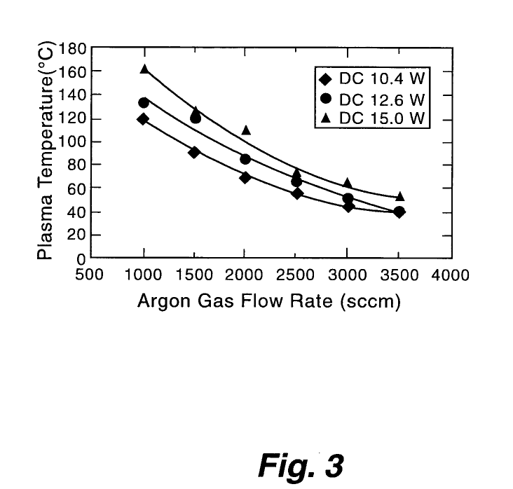

The temperature of an argon plasma generated using an embodiment plasma brush generator of the invention was measured at different power levels using a thermocouple thermometer. As FIG. 3 shows, the plasma temperature was closely related to the applied power and the plasma gas flow rate. For a gas flow rate of about 1000 sccm and plasma power of about 15 watts, the measured plasma temperature was about 160 degrees Celsius. When the plasma power was reduced to 12.6 Watts, at the same plasma gas flow rate, the plasma temperature lowered to about 140 degrees Celsius. Plasma power of about 10.4 Wafts at the same plasma gas flow rate produced a plasma with a temperature of about 120 degrees Celsius. Increasing the argon flow rate from about 1000 sccm to about 3500 sccm led to a reduction in the plasma gas temperature of from about 160 degrees Celsius to about 53 degrees Celsius at a power level of 15.0 Watts, and from 120 degrees Celsius to about 40 degrees Celsius at 10.4 Watts. These results illustrate how the plasma temperature can be adjusted, and the results also illustrate the low temperature (i.e. less than about 300 degrees Celsius) nature of the invention. Further increases of plasma gas flow rate, for example, would decrease the temperature even further to a temperature approaching room temperature. The low-temperatures enable the plasma brush generator for surface treatment of polymers.

Samples of polymer films of polyethyleneterephthalate (PET), nylon 6,6 (PA 6,6), silicone rubber (elastomer) (SR), polypropylene (PP), and low-density polyethylene (LDPE) were prepared by cutting the films into strips, cleaning them in an ultrasonic bath with soap water for 30 minutes, and then thoroughly rinsing them with deionized (DI) water for 60 minutes, then drying them in air. After these procedures, the strips were subjected to surface treatment using a plasma brush. The polymer samples were put on a stage under the discharge chamber. After argon gas at a certain flow rate (1500 sccm, for example) was fed into the discharge chamber through the gas line, a DC voltage (1500 V, for example) was applied to create a plasma brush. With an argon flow rate of 1500 sccm and 15 W of DC power, the luminous atmospheric cold plasma brush length was about 1.3 cm from the output of the discharge chamber. During the plasma treatment, the polymer samples were kept in a predetermined exposure position.

The static contact angles of polymer samples were measured by projecting an image of an automated sessile droplet resting on a membrane surface using a VCA-2500XE Video Contact Angle System (AST PRODUCTS, INC.). For comparison purposes, both untreated and treated polymer samples were placed on a vertically and horizontally adjustable sample stage. Above the stage is the tip of a microsyringe. A computer was used to control the microsyringe to dispense a 0.3 microliter water droplet on each sample. Afterward, a snapshot was taken, and the image was saved and contact angle measurements were performed. Markers were placed around the perimeter of the water droplet, and then the VCA-2500 DYNAMIC/WINDOWS software calculated right and left contact angles.

The measured surface contact angle is used to quantitatively characterize the surface wettability of a polymer surface. Surface wettability is a term that is describes the surface properties of a solid (in this case, a polymer). In particular, surface wettability is a measure of how a polymer surface can be wetted by a liquid such as, but not limited to water, ink, paint, solvent, etc. A low surface contact angle of a specific liquid such as water on a solid surface indicates that surface is very wettable by the specific liquid. In contrast, a high contact angle indicates a poor wettability to the specific liquid used. In the case of the present invention, the liquid used for making surface contact angle measurements is water.

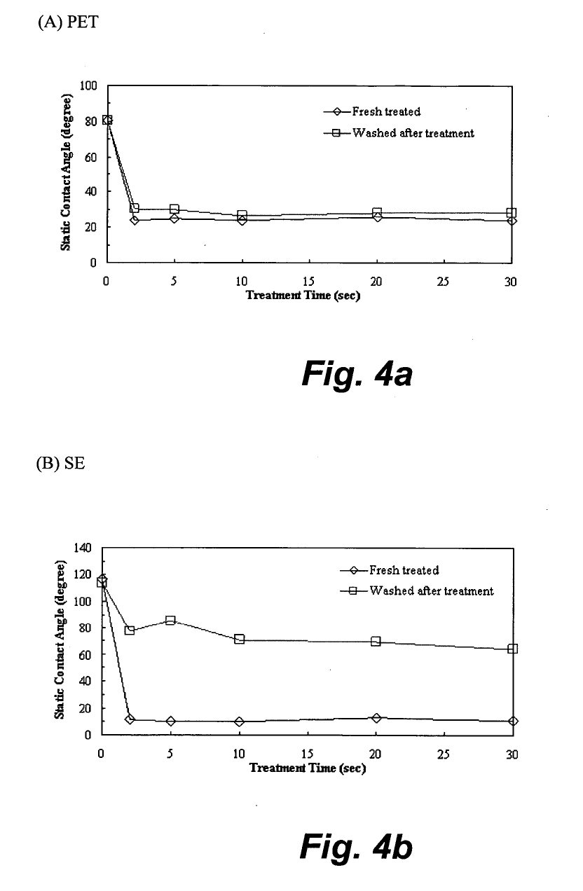

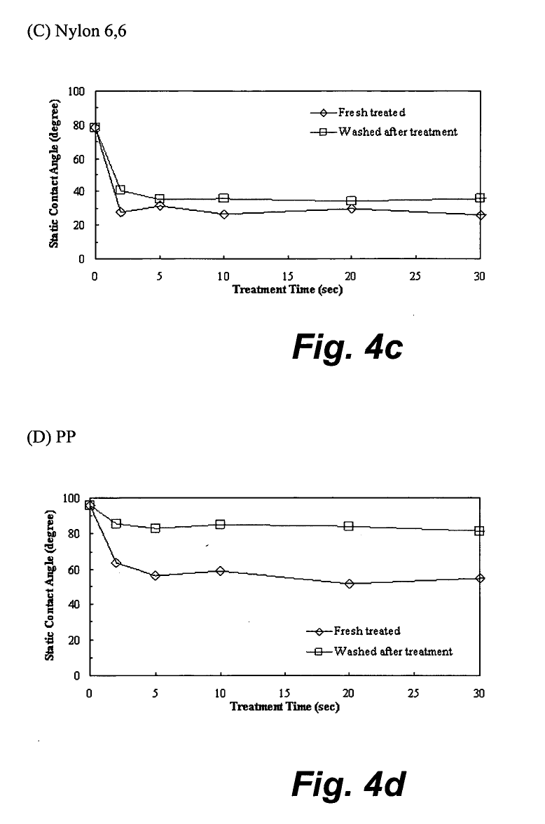

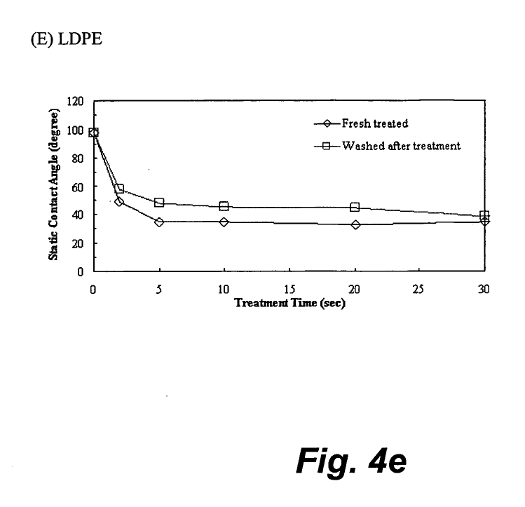

The static water contact angles were measured as a function of the exposure time to the plasma brush. FIG. 4 shows a plot of the static water contact angle in degrees versus the exposure time for the polymer samples selected. The lines with diamond symbols indicate static water contact angle measurements for polymer directly after the plasma treatment. The lines with box symbols indicate static water contact angle measurements for the corresponding polymer samples after plasma treatment followed by washing them with deionized (DI) water. As FIG. 4a and FIG. 4b illustrate, PET and silicone elastomer (SE) samples have initial static water contact angles of approximately 80° and 1200, respectively. A plasma treatment for about 2 seconds dramatically decreases these angles for both samples (see FIG. 4a and FIG. 4b). This decrease indicates that the plasma treatment resulted in an increase in the surface wettability of these polymer samples. After washing with water, the water contact angle for PET did not change substantially, while that for the silicone elastomer showed a significant increase from about 10° to about 80°. While not intending to be bound by any particular explanation, the recovery of hydrophobicity as evidenced by the increase in the static water contact angle after washing may be due to washing away of surface oligomers that formed during the plasma treatments.

The changes in static water contact angle of nylon 6,6, PP, and LDPE samples on exposure to atmospheric plasma treatment are shown in FIGS. 4c, 4d, and 4e, respectively. For these polymers, plasma treatment using the atmospheric pressure, low temperature plasma brush resulted in a tremendous decrease in static water contact angle compared to the original sample.

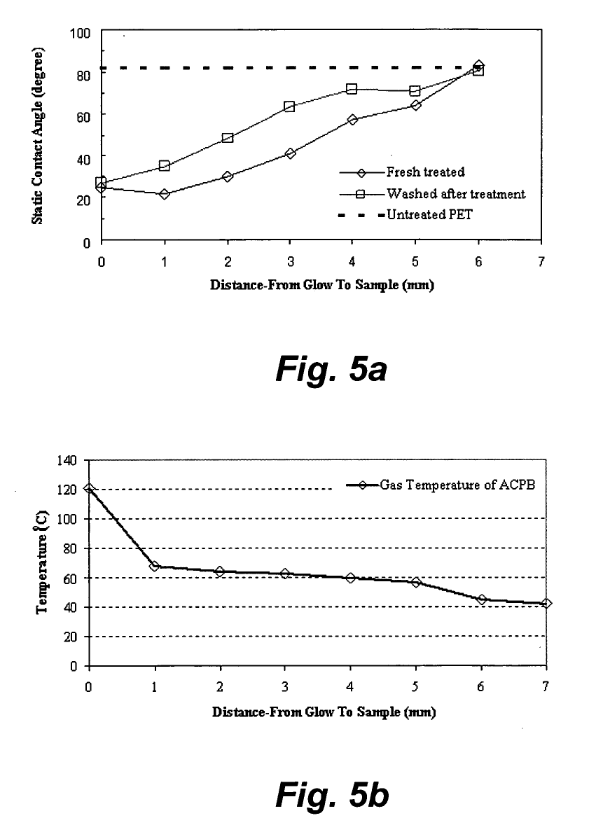

Polymer substrates were also placed away from, but near, the tip of the glowing plasma brush. FIG. 5a shows a graph of static water contact angle of a PET sample as a function of distance away from the tip of the plasma brush. As FIG. 5a shows, placing the sample about 1 mm from the visibly glowing tip of the plasma brush produced a static water contact angle of about 22°. As the sample was moved further and further away, smaller changes in the static water contact angle were observed (the exposure time being the same).

FIG. 5b shows the gas phase temperatures at different positions away from the glowing tip of the plasma brush. According to FIG. 5b, the gas phase temperature decreases with increasing distance from the glow region of the plasma. Thus, a remote exposure of a polymer substrate to the atmospheric pressure plasma (i.e. an exposure away from, but near, the plasma) allows for surface treatment at a lower temperature.

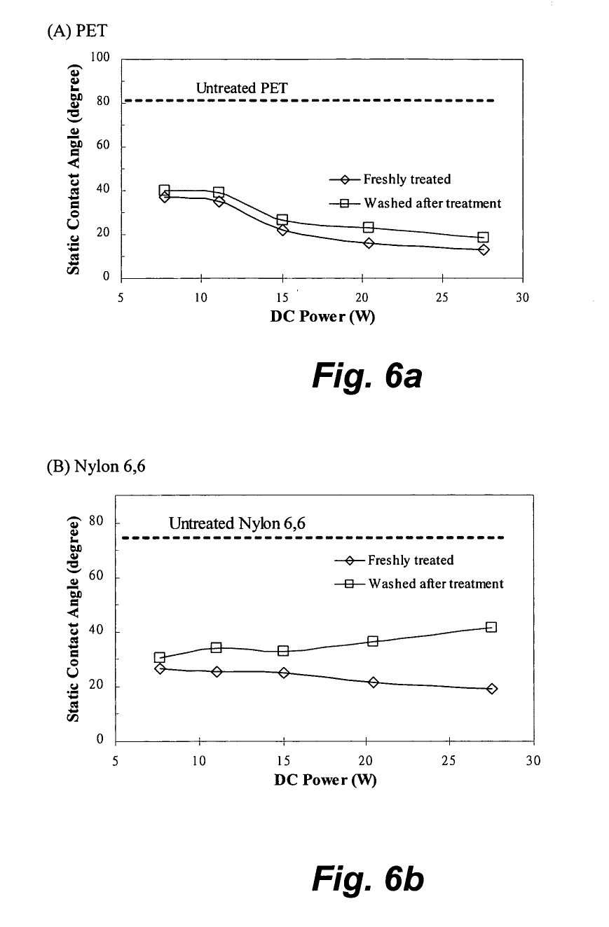

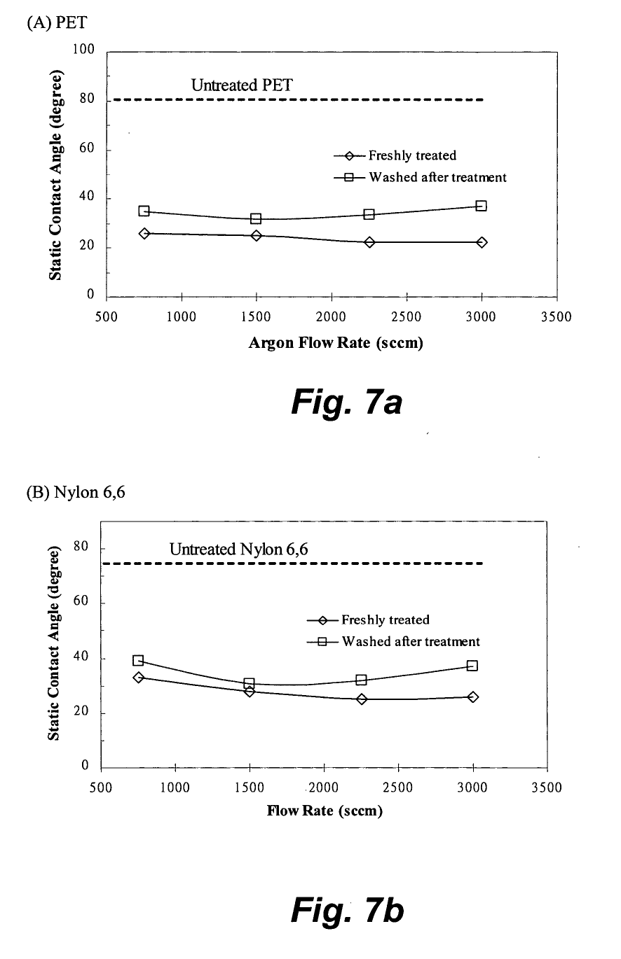

The surface treatment of PET films by atmospheric pressure plasma brush was carried out at different DC power inputs (FIG. 6) and argon flow rates (FIG. 7). FIG. 6 shows the static contact angle changes of PET and Nylon 6,6 with different DC power inputs of the plasma under a fixed argon flow at 1500 sccm and a treatment time of 10 seconds. It can be seen from FIG. 6 that a higher DC power input resulted in a lower static contact angle (i.e. a higher surface wettability) for both PET and Nylon 6,6 surfaces. As shown in FIG. 7, argon flow rate did not have much effect on decreasing the surface contact angles of PET and Nylon 6,6.

Plasma brush treated polymer samples were also monitored for aging effects because effects due to aging could limit the usefulness of atmospheric plasma treated polymeric materials. The effects of aging on atmospheric plasma treated polymer samples were investigated by storing the samples in ambient air for more than 100 hours. After about 120 hours aging, atmospheric plasma treated PET nylon 6,6 and LDPE samples showed the good surface hydrophilicity. By contrast, atmospheric plasma treated SR and PP samples showed hydrophobic recovery.

In summary, an atmospheric pressure, low temperature plasma brush was used to treat the surfaces of polymers. A variety of materials were treated, including polyethyleneterephthalate (PET), silicone rubber (elastomer) (SR), nylon 6,6 (PA 6,6), polypropylene (PP), and low-density polyethylene (LDPE). In most cases, a lower water contact angle resulted from the treatment, indicating an increase in the surface free energy. In most cases, the treatment resulted in an increase in the surface wettability (i.e. the surface hydrophilicity) compared to the untreated polymers, with good retention on aging. Some of the advantages of treating a polymer surface according to the invention include: (1) a short treatment time; (2) low power; (3) low gas temperature, approaching room temperature; (4) an atmospheric pressure plasma source; (5) minimal amount of chemicals; and (6) cost: the process is relatively inexpensive compared to current polymer surface treatment processes.

The foregoing description of the invention has been presented for purposes of illustration and description and is not intended to be exhaustive or to limit the invention to the precise form disclosed, and obviously many modifications and variations are possible in light of the above teaching. For example, while all of the materials used in demonstrating the invention were polymer sheets, it is expected that the invention can also be used with other forms of polymer (fibers, for example). In addition, while the invention was used to change the surface wettability of man-made polymers, it is expected that it could also be used to change the surface wettability of naturally occurring polymers such as silk, cotton, wool, rubber, and the like.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for treating the surface of a polymer, comprising:
generating an atmospheric pressure plasma brush that comprises a temperature T wherein T≦300 degrees Celsius, and
exposing a surface of a polymer having a surface wettability to a plasma brush for a duration sufficient to change the surface wettability of the polymer.

2. The method of claim 1, wherein the polymer is selected from the group consisting of polyolefins, polycarbonates, silicone rubber, fluorinated polyolefins, and polyamides.

3. The method of claim 1, wherein the polymer is selected from the group consisting of polyethyleneterephthalate, silicone rubber, nylon, polypropylene, and polyethylene.

4. The method of claim 1, wherein the step of exposing the polymer to the plasma brush results in a decrease in the water contact angle of the polymer.

5. The method of claim 1, where the temperature of the plasma brush is T wherein T≦200 degrees Celsius.

6. The method of claim 1, wherein the temperature of the plasma brush is T wherein T≦140 degrees Celsius.

7. The method of claim 1, wherein the temperature of the plasma brush is T wherein T≦120 degrees Celsius.

8. The method of claim 1, wherein the temperature of the plasma brush is T wherein T≦53 degrees Celsius.

9. The method of claim 1, wherein the temperature of the plasma brush is about room temperature.

10. The method of claim 1, wherein the atmospheric pressure plasma brush comprises plasma gas selected from the group consisting of helium, argon, nitrogen, oxygen, air, vapor of hydrocarbons, and mixtures thereof.

11. A method for treating the surface of a polymer, comprising:
generating an atmospheric pressure plasma brush that comprises a glow and a temperature T wherein T≦300 degrees Celsius, and
positioning the glow of the atmospheric plasma brush near a surface of a polymer having a surface wettability for a duration sufficient to change the surface wettability of the polymer.

12. The method of claim 11, wherein the polymer is selected from the group consisting of polyolefins, polycarbonates, silicone rubbers, and polyamides.

13. The method of claim 11, wherein the polymer is selected from the group consisting of polyethyleneterephthalate, silicone rubber, nylon, polypropylene, and polyethylene.

14. The method of claim 11, wherein the step of exposing the polymer to the plasma brush results in a decrease in the water contact angle of the polymer.

15. The method of claim 11, where the temperature of the plasma brush is T wherein T≦160 degrees Celsius.

16. The method of claim 11, wherein the temperature of the plasma brush is T wherein T≦140 degrees Celsius.

17. The method of claim 11, wherein the temperature of the plasma brush is T wherein T≦120 degrees Celsius.

18. The method of claim 11, wherein the temperature of the plasma brush is T wherein T≦53 degrees Celsius.

19. The method of claim 11, wherein the temperature of the plasma brush is about room temperature.

20. The method of claim 11, wherein the atmospheric pressure plasma brush comprises plasma gas selected from the group consisting of helium, argon, nitrogen, oxygen, air, vapor of hydrocarbons, and mixtures thereof.
